(19) United States
(12) Patent Application Publication
(10) Pub. No.: US 2024/0088738 A1
(43) Pub. Date: Mar. 14, 2024

(54) MOTOR

(71) Applicant: LG INNOTEK CO., LTD., Seoul (KR)

(72) Inventor: Bong Geon KIM, Seoul (KR)

(73) Assignee: LG INNOTEK CO., LTD., Seoul (KR)

(21) Appl. No.: 18/272,433

(22) PCT Filed: Jan. 14, 2022
(86) PCT No.: PCT/KR2022/000725

§ 371 Date: Jul. 14, 2023

(30) Foreign Application Priority Data
Jan. 15, 2021 (KR) 10-2021-0005918

(51) Int. Cl. H02K 3/52

(52) U.S. Cl. CPC H02K 3/522; H02K 2203/09

(57) ABSTRACT

The present invention may provide a motor including a shaft, a rotor coupled to the shaft, a stator disposed to correspond to the rotor, busbars disposed on the stator, and a busbar holder which supports the busbars, wherein the stator includes a stator core, an insulator coupled to the stator core, and a coil disposed on the insulator, the busbar holder includes a hole through which the coil passes, and each of the busbars includes a straight end portion which is exposed from the busbar holder and is in contact with the coil which passes through the hole.

### TECHNICAL FIELD

The embodiment relates to a motor.

### BACKGROUND ART

In a motor, a rotor generally rotates due to an electromagnetic interaction with a stator. In this case, a shaft connected to the rotor also rotates to generate a rotational driving force.

The stator may include a stator core, an insulator mounted on the stator core, and coils wound around the insulator. The coils can be connected to busbars. Each of the busbars is supported by a busbar holder.

An end portion of the busbar and an end portion of one of the coils are connected by fusing. A welding rod is positioned between the adjacent coils in a circumferential direction in order to perform fusing, and the busbar may be formed to have two stages in an axial direction to secure a space in which the welding rod is positioned. When the busbar is formed to have two stages in the axial direction as described above, the shape of the busbar becomes complicated, a large amount of scrap is generated in a production process of the busbar, a space occupied by the busbar increases in the axial direction, and thus there is a big problem in designing the motor.

### DISCLOSURE

### Technical Problem

An embodiment is directed to providing a motor in which a shape of a busbar is simplified and a space occupied by the busbar in an axial direction is reduced.

Objectives to be solved by the present invention are not limited to the above-described objectives, and the other objectives which are not described above will be clearly understood by those skilled in the art from the following description.

### Technical Solution

One aspect of the present invention provides a motor including a shaft, a rotor coupled to the shaft, a stator disposed to correspond to the rotor, busbars disposed on the stator, and a busbar holder which supports the busbars, wherein the stator includes a stator core, an insulator coupled to the stator core, and a coil disposed on the insulator, the busbar holder includes a hole through which the coil passes, and each of the busbars includes a straight end portion which is exposed from the busbar holder and is in contact with the coil which passes through the hole.

Another aspect of the present invention provides a motor including a shaft, a rotor coupled to the shaft, a stator disposed to correspond to the rotor, busbars disposed on the stator, and a busbar holder which supports of the busbars, wherein the stator includes a stator core, an insulator coupled to the stator core, and a coil disposed on the insulator, each of the busbars includes a curved part and a plurality of flat parts bent from the curved part, and each of the flat parts is in contact with the coil.

### Advantageous Effects

According to an embodiment, since a space in which a welding rod is positioned in a circumferential direction is secured using a busbar including a straight end portion, and the busbar is formed to have one stage, a shape of the busbar is simplified, and thus there is an advantage of reducing scrap generated in a manufacturing process of the busbar.

According to an embodiment, since a busbar is formed to have one stage, a space occupied by the busbar in an axial direction is reduced, and thus there is an advantage of easily designing a motor.

According to an embodiment, since a region fused to a coil is a straight end portion, a process of bending the end portion of a busbar is omitted, and thus there is an advantage of simplifying a manufacturing process of a motor.

According to an embodiment, there is an advantage of easily aligning a position of an end portion of a coil fused to a busbar and the busbar using a hole of a busbar holder.

### DESCRIPTION OF DRAWINGS

FIG. 1 is a side cross-sectional view illustrating a motor according to an embodiment.

FIG. 2 is a perspective view illustrating a busbar holder and busbars.

FIG. 3 is a plan view illustrating the busbar holder and the busbars illustrated in FIG. 2.

FIG. 4 is a view illustrating the busbars.

FIG. 5 is a plan view illustrating the busbars illustrated in FIG. 4.

FIG. 6 is a perspective view illustrating a first busbar.

FIG. 7 is a development view illustrating the first busbar illustrated in FIG. 6.

FIG. 8 is a perspective view illustrating a second busbar illustrated in FIG. 6.

FIG. 9 is a perspective view illustrating a third busbar illustrated in FIG. 6.

FIG. 10 is a perspective view illustrating a fourth busbar illustrated in FIG. 6.

FIG. 11 is a development view illustrating the fourth busbar illustrated in FIG. 10.

FIG. 12 is a perspective view illustrating a fifth busbar.

FIG. 13 is a side cross-sectional view illustrating the busbar and the busbar holder along line A-A of FIG. 2.

FIG. 14 is a view illustrating a state in which the busbars and the busbar holder of FIG. 2 are mounted on a stator.

FIG. 15 is a view illustrating positions of a flat part of the busbar, a coil, and a welding rod.

### MODES OF THE INVENTION

A direction parallel to a longitudinal direction (vertical direction) of a shaft is referred to as an axial direction, a direction perpendicular to the axial direction of the shaft is referred to as a radial direction, and a direction along a circle having a radius in the radial direction from the shaft is referred to as a circumferential direction.

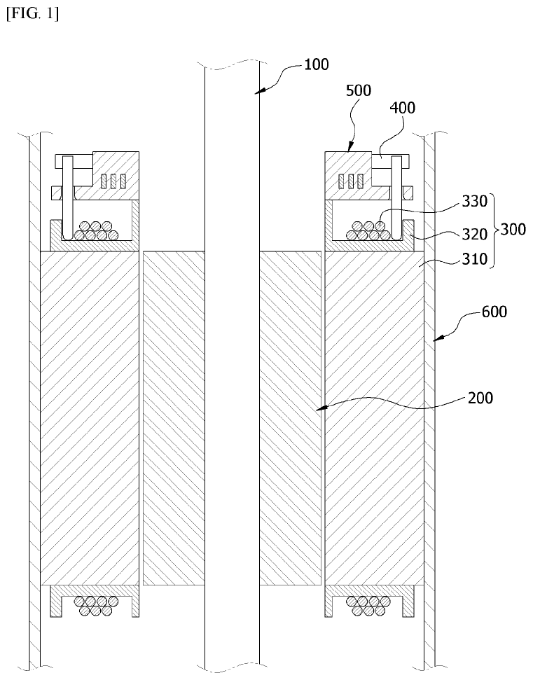

FIG. 1 is a side cross-sectional view illustrating a motor according to an embodiment.

Referring to FIG. 1, the motor according to the embodiment may include a shaft 100, a rotor 200, a stator 300, busbars 400, a busbar holder 500, and a housing 600. Hereinafter, the term “inward” is a direction from the housing 600 toward the shaft 100 which is a center of the motor, and the term “outward” is a direction opposite to “inward,” that is, a direction from the shaft 100 toward the housing 600.

The shaft 100 may be coupled to the rotor 200. When a current is supplied and an electromagnetic interaction occurs between the rotor 200 and the stator 300, the rotor 200 rotates and the shaft 100 rotates in conjunction with the rotation of the rotor 200.

The rotor 200 rotates due to an electrical interaction with the stator 300. The rotor 200 may be disposed inside the stator 300 to correspond to the stator 300. The rotor 200 may include a magnet.

The stator 300 is disposed outside the rotor 200. The stator 300 may include a stator core 310, an insulator 320, and coils 330. The insulator 320 is seated on the stator core 310. Each of the coils 330 is mounted on the insulator 320. The coil 330 induces an electrical interaction with the magnet of the rotor 200.

Each of the busbars 400 may be disposed on the stator 300. The busbar 400 is electrically connected to the coil 330. The busbar 400 may be connected to an external power supply.

The busbar holder 500 supports the busbar 400. The busbar holder 500 may be an annular member including the busbar 400 therein.

The housing 600 may be disposed outside the stator 300. The housing 600 may be a cylindrical member of which one side is open.

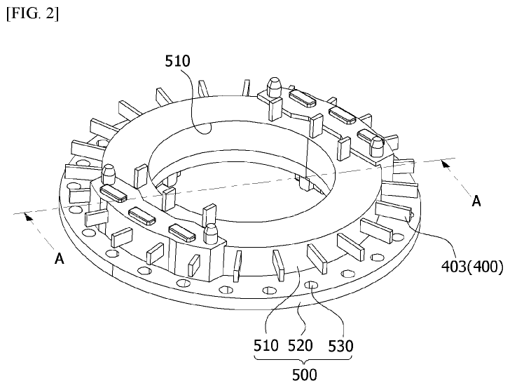

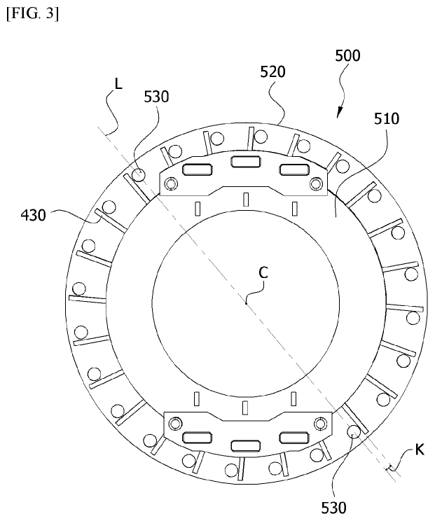

FIG. 2 is a perspective view illustrating the busbar holder 500 and the busbars 400, and FIG. 3 is a plan view illustrating the busbar holder 500 and the busbars 400 illustrated in FIG. 2.

Referring to FIGS. 2 and 3, the busbar 400 is fixed to the busbar holder 500. In the busbar 400, a part of each flat part 403 disposed in a shape of a straight end portion protrudes outward from the busbar holder 500. The busbar holder 500 may include a holder body 510 and an extension 520 extending outward from an outer surface of the holder body 510.

A plurality of holes 530 are disposed in the extension 520. Each of the holes 530 may be formed to pass through one surface and the other surface of the extension 520 in an axial direction. The hole 530 is for a position of the coil to be arranged with and fused to the busbar 400. When the busbar holder 500 is mounted on the stator 300, the coil passes through the hole 530 and is positioned on the extension 520 based on the drawings.

A hole 530 through which the shaft 100 passes is formed in a central portion of the holder body 510. Apart of the flat part 403 of the busbar 400 protrudes further than the outer surface of the holder body 510. The extension 520 may be positioned under the flat part 403 of the busbar 400 based on the drawings so that the flat part 403 is positioned at a position of the extension 520.

The plurality of holes 530 may be disposed in a circumferential direction of the busbar holder 500. An outer end of the straight end portion of the busbar 400 may be disposed outside the hole 530 and may be disposed inside an outer edge of the busbar holder 500. The holes 530 may be point-symmetrically disposed with respect to a center C of the busbar 400. Two holes 530 may be disposed on a reference line L passing through the center C of the busbar 400. The reference line L may be disposed to be spaced a predetermined distance k from the flat part 403 of the busbar 400 in the circumferential direction. For example, the flat part 403 of the busbar 400 may be disposed outside the hole 530 in the axial direction so that the flat part 403 of the busbar 400 does not overlap the hole 530 in the axial direction.

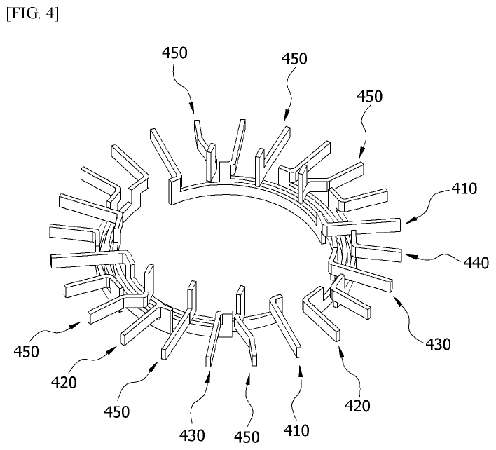

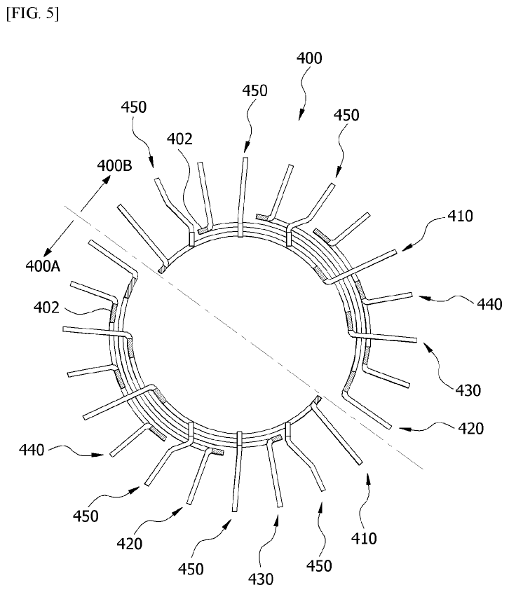

FIG. 4 is a view illustrating the busbars 400, and FIG. 5 is a plan view illustrating the busbars 400 illustrated in FIG. 4.

Referring to FIGS. 3 to 5, the busbars 400 may include first busbars 410, second busbars 420, and third busbars 430 which are phase busbars. The first busbars 410, the second busbars 420, and the third busbars 430 may be connected to U-phase, V-phase, and W-phase power supplies, respectively. And the busbars 400 may include fourth busbars 440 which are neutral busbars 400. In addition, the busbars 400 may include fifth busbars 450 each connected to an external power supply. The first busbars 410, the second busbars 420, the third busbars 430, the fourth busbars 440 and the fifth busbars 450 are electrically connected through the coils 330.

The busbar 400 may include flat parts 403 in shapes of straight end portions in contact with the coils 330. A plurality of flat parts 403 may be arranged radially.

A plurality of busbars 400 may be divided into a first group 400A and a second group 400B. Each of the first group 400A and the second group 400B may include the first to fifth busbars 410, 420, 430, 440, and 450. The first group 400A and the second group 400B may be disposed to be electrically separated from each other. The coils 330 in contact with the first group 400A and the coils 330 in contact with the second group 400B may be disposed to be electrically separated from each other.

The first group 400A and the second group 400B may be disposed to be spatially divided. Hereinafter, features of the busbar 400 described below correspond to common features of the busbars 400 of the first group G1 and the second group G2.

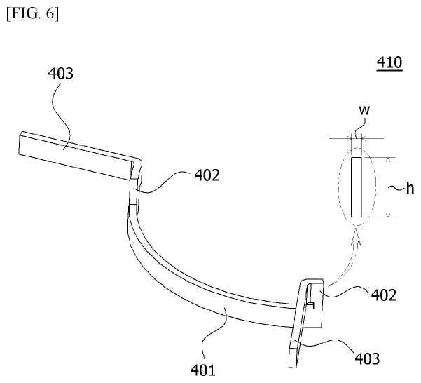

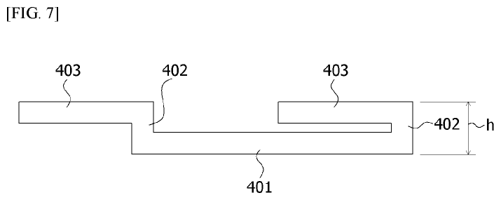

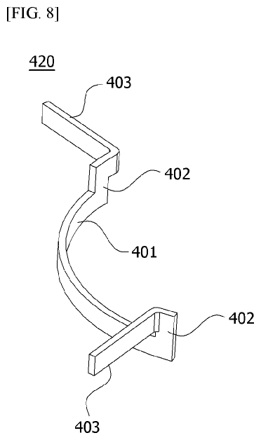

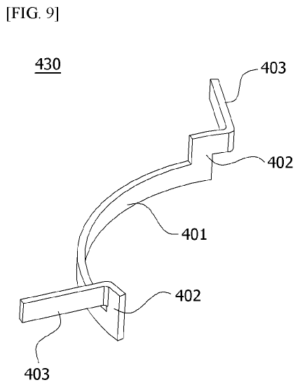

FIG. 6 is a perspective view illustrating the first busbar 410, and FIG. 7 is a development view illustrating the first busbar 410 illustrated in FIG. 6. FIG. 8 is a perspective view illustrating the second busbar 420 illustrated in FIG. 6, and FIG. 9 is a perspective view illustrating the third busbar 430 illustrated in FIG. 6.

Hereinafter, referring to FIGS. 6 to 9, the first busbar 410, the second busbar 420, and the third busbar 430, which are the phase busbars, will be described. Each of the first busbar 410, the second busbar 420, and the third busbar 430 may include curved parts 401 and 402 and the flat parts 403. Only lengths of the curved parts 401 and 402 in the circumferential direction of the first busbar 410, the second busbar 420, and the third busbar 430 may be different, and total lengths in the axial direction or shapes of the busbars 400 may be the same.

The features of the phase busbar 400 described below will be described based on the first busbar 410, and the described features correspond to the common features applied to the second busbar 420 and the third busbar 430.

The curved parts 401 and 402 may be divided into a body 401 and protrusions 402. The body 401 is a member having a band shape and is fixed in the holder body 510 of the busbar holder 500 in a bent shape. A plurality of protrusions 402 may be branched off from the second body 401. In the first busbar 410, two protrusions 402 may be disposed on both end portions of the body 401.

The flat part 403 may be formed to be bent outward from each of the protrusions 402. The flat part 403 is the straight end portion welded to the coil 330. As a region of the busbar 400 in contact with the coil 330 is formed as a straight end portion, the flat part 403 may be implemented parallel to the curved parts 401 and 402 based on the development view. Accordingly, there is an advantage of implementing the flat part 403 welded to the coil 330 in a state in which a length of the busbar 400 is significantly reduced in the axial direction.

The second body 401 and the flat part 403 may be disposed to be spaced apart from each other in the axial direction. One surface of the protrusion 402 may be disposed to be coplanar with one surface of the flat part 403.

In the first busbar 410, the flat parts 403 and the curved part 401 and 402 are disposed parallel to each and formed in similar rectangular shapes based on the development view. Accordingly, a region in which the busbar 400 is formed is small in the axial direction, and a shape of the development view is simple, and thus there is an advantage of significantly reducing scrap.

The first busbar 410 may be disposed in the busbar holder 500 to stand up based on the drawings so that a length h of the first busbar 410 in the axial direction is greater than a length w of the first busbar 410 in the circumferential direction.

One surfaces of the flat parts 403 of the first busbar 410, the second busbar 420, and the third busbar 430 may be disposed to be coplanar with each other.

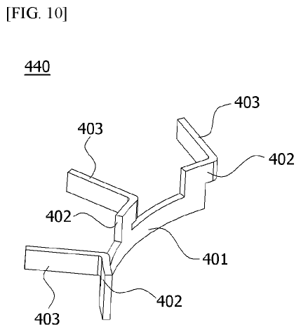

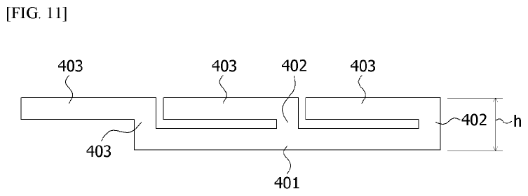

FIG. 10 is a perspective view illustrating the fourth busbar 440 illustrated in FIG. 6, and FIG. 11 is a development view illustrating the fourth busbar 440 illustrated in FIG. 10.

Referring to FIGS. 10 and 11, the fourth busbar 440, which is the neutral busbar 400, may also include curved parts 401 and 402 and flat parts 403. For example, the fourth busbar 440 may have two protrusions 402 disposed on both end ports of a body 401, and one protrusion 402 may be additionally disposed between the two protrusions 402. Three protrusions 402 are formed in bent shapes to be connected to the flat parts 403. In addition, in the fourth busbar 440 based on the development view, three flat parts 403 and the curved parts 401 and 402 are disposed parallel to each other and formed in similar rectangular shapes, one surface of each of the protrusions 402 is disposed to be coplanar with one surface of each of the flat parts 403, and thus there is an advantage of simplifying a shape of the development view.

One surface of the flat part 403 of the fourth busbar 440 may be disposed to be coplanar with one surface of each of the flat parts 403 of the first busbar 410, the second busbar 420, and the third busbar 430.

Referring to FIG. 5, the protrusions 402 (shaded portions of FIG. 5) of the first busbar 410, the second busbar 420, and the third busbar 430 may be disposed not to overlap the protrusions 402 (shaded portions of FIG. 5) of the fourth busbar 440 in a radial direction.

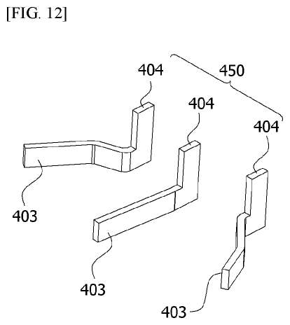

FIG. 12 is a perspective view illustrating the fifth busbar 450.

Referring to FIG. 12, the fifth busbar 450 is the busbar 400 connected to the external power supply and includes flat parts 403 in contact with the coils 330. In addition, the fifth busbar 450 may include connecting parts 404 branched off from the flat parts 403. Each of the connecting parts 404 is connected to the external power supply. An end of the connecting part 404 is exposed from the busbar holder 500.

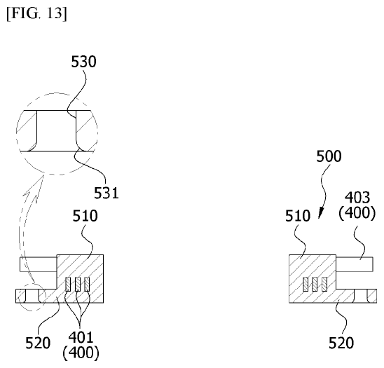

FIG. 13 is a side cross-sectional view illustrating the busbar 400 and the busbar holder 500 along line A-A of FIG. 2.

Referring to FIG. 13, the body 401 of the busbar 400 is disposed in the holder body 510 of the busbar holder 500. The flat part 403 of the busbar 400 is exposed from the holder body 510 and positioned on the extension 520. An entrance of the hole 530 that the coil 330 enters may include a curved portion 531. In a process of mounting the busbar holder 500 on the stator 300, the coil 330 enters the hole 530, and the curved portion 531 guides the coil 330 to easily enter the hole 530 without being caught. A size of the hole 530 may be slightly greater than an outer diameter of the coil 330 in consideration of the entry of the coil 330 and the alignment of the coil 330.

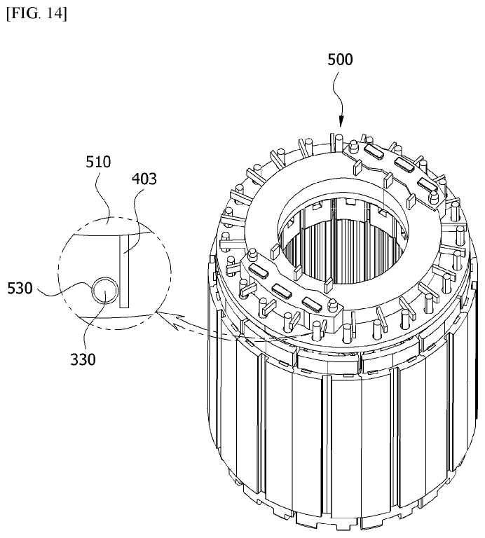

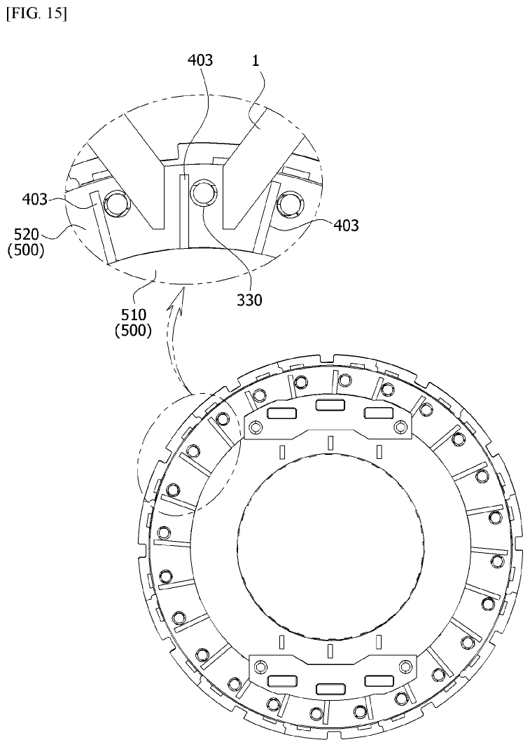

FIG. 14 is a view illustrating a state in which the busbars 400 and the busbar holder 500 of FIG. 2 are mounted on the stator 300, and FIG. 15 is a view illustrating positions of the flat part 403 of the busbar 400, the coil 330, and a welding rod.

Referring to FIGS. 14 and 15, in a state in which the busbar holder 500 is mounted on the stator 300, the coil 330 passes through the hole 530 and exposed upward from the busbar holder 500 based on the drawings. The coil 330 passing through the hole 530 is arranged with the flat part 403 of the busbar 400. The coil 330 is disposed in contact with or close to a side surface of the flat part 403.

Welding rods 1 are positioned at both sides of the flat part 403 and the coil 330 in the circumferential direction. And each of the welding rods 1 may be disposed between the adjacent flat parts 403 in the circumferential direction. When a region in which the busbar 400 and the coil 330 are fused is bent, a significant distance is required between the adjacent busbars 400 in the circumferential direction to secure a space in which the welding rod 1 is positioned. However, in the motor according to the embodiment, since the flat part 403 has the shape of the straight end portion, the space in which the welding rod 1 is positioned can be sufficiently secured even when the distance between the adjacent busbars 400 is small in the circumferential direction. Accordingly, there is an advantage of implementing the busbar 400 to have the one stage in the axial direction.

In the present invention, an example of the motor including the busbars 400 divided into the first group 400A and the second group 400B has been described, but the present invention is not limited thereto. The present invention may also be applied to a motor including busbars 400 electrically connected to each other as one busbar 400. In addition, the present invention can be used in various devices such as vehicles or home appliances.

1-10. (canceled)

11. A motor comprising:
a shaft;
a rotor coupled to the shaft;
a stator disposed to correspond to the rotor;
busbars disposed on the stator; and
a busbar holder which supports of the busbars,
wherein the stator includes a stator core, an insulator coupled to the stator core, and a coil disposed on the insulator,
each of the busbars includes a curved part and a plurality of flat parts bent from the curved part, and
each of the flat parts is in contact with the coil,
wherein the curved part includes a body and a plurality of protrusions branched off from the body in an axial direction and the flat part is formed to be bent outward from the protrusion,
wherein the flat part is in contact with the coil,
wherein the body and the flat part are disposed to be spaced apart from each other in the axial direction, and
wherein one surface of each of the protrusions is disposed to be coplanar with one surface of the flat part.

12. The motor of claim 11, wherein:
the busbar holder includes a hole through which the coil passes; and
the flat part which is exposed from the busbar holder is in contact with the coil which passes through the hole.

13. The motor of claim 11, wherein:
the busbar holder includes a holder body to which the busbar is fixed and an extension extending outward from an outer surface of the holder body;
the hole is disposed to pass through one surface and the other surface of the extension; and
the flat part is disposed to protrude further than the outer surface of the holder body.

14. The motor of claim 12, wherein an outer end of the flat part is disposed outside the hole and disposed inside an outer edge of the busbar holder.

15. The motor of claim 11, wherein the busbar is disposed not to overlap the hole in an axial direction.

16. The motor of claim 12, wherein:
the flat part is formed to be bent outward from the protrusion.

17. The motor of claim 11, wherein the coil include a curved portion.

18. The motor of claim 13, wherein the flat part of the busbar is exposed from the holder body 510 and positioned on the extension.

19. The motor of claim 11, wherein all of the protrusions disposed on the busbars are disposed not to overlap in a radial direction.

20. The motor of claim 11, comprising a plurality of phase busbars in which at least some of the busbars overlap each other in a radial direction,
wherein one surfaces of the plurality of phase busbars are coplanar with each other in an axial direction.
